(19) United States
(12) Patent Application Publication
(10) Pub. No.: US 2007/0115592 A1
(43) Pub. Date: May 24, 2007

(54) Hard disk drive and method of fabricating the same

(75) Inventors: Do-wan Kim, Hwaseong-si (KR); Ki-tag Jeong, Hwaseong-si (KR); Woo-cheol Jeong, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/513,380

(22) Filed: Aug. 31, 2006

(30) Foreign Application Priority Data
Nov. 22, 2005 (KR) 2005-111997

(51) Int. Cl. G11B 5/55

(52) U.S. Cl. 360/264.3; 360/265.1

(57) ABSTRACT

A hard disk drive and a method of fabricating the same. The hard disk drive includes a base member and a cover member of which outer circumferences are combined with each other and which form an internal space, an actuator mounted on the base member to be pivoted, a voice coil motor (VCM) including a lower VCM block and an upper VCM block which are separated from each other so that a rear portion of the actuator is interposed therebetween, and a crash stopper to collide with the rear portion of the actuator and to restrict a pivot range of the actuator, having an upper-end to be accommodated in the upper VCM block so that a location change of the upper VCM block caused by an external disturbance is prevented.

### CROSS-REFERENCE TO RELATED APPLICATIONS

This application claims the benefit of Korean Patent Application No. 10-2005-0111997, filed on Nov. 22, 2005, in the Korean Intellectual Property Office, the disclosure of which is incorporated herein in its entirety by reference.

### BACKGROUND OF THE INVENTION

1. Field of the Invention

The present general inventive concept relates to a hard disk drive, and more particularly, to a voice coil motor (VCM) to fix an upper VCM block and a lower VCM block so that the upper VCM block is disposed at a predetermined position with respect to the lower VCM block in a hard disk drive.

2. Description of the Related Art

A hard disk drive (HDD), an auxiliary memory device used in a computer system, an MP3 player, and a mobile phone, etc., records data on a disk, i.e., a storage medium, or reproduces the data recorded on the disk using an actuator having a magnetic head. The actuator is mounted on a base member and pivots clockwise or counterclockwise so that the magnetic head can search a location where data is to be recorded on the disk or a location where the data is recorded in order to reproduce the data. The actuator is driven by an electromagnetic force generated by an interaction between a current input to a voice coil motor (VCM) coil at a rear portion of the actuator and a magnetic field formed by a magnet of the VCM.

FIG. 1 is an exploded perspective view partially illustrating a conventional VCM 10. Referring to FIG. 1, the VCM 10 includes a lower VCM block 11 and an upper VCM block 15 separated from each other so that a rear portion of the actuator (not shown) can be interposed between the lower VCM block 11 and the upper VCM block 15. The lower VCM block 11 is mounted on a base member 1. At least one combining protrusion 17 is disposed in the upper VCM block 15, and at least one combining groove 13 is disposed in the lower VCM block 11 to accommodate the combining protrusion 17. In order to fix the upper VCM block 15 in the lower VCM block 11, the lower VCM block 11 and the upper VCM block 15 are combined with each other by placing an adhesive 20 in the combining groove 13 and inserting the combining protrusion 17 in the combining groove 13 when assembling the VCM 10. Reference numeral 5 denotes a crash stopper mounted on the base member 1 so as to restrict a pivot range of the actuator (not shown).

However, it is difficult to automatize an operation of assembling the VCM 10 using the adhesive 20 for mass production and mounting the actuator (not shown) in the hard disk drive. Consequently, productivity of the hard disk drive is low.

### SUMMARY OF THE INVENTION

The present general inventive concept provides a hard disk drive (HDD) in which an upper voice coil motor (VCM) block of a VCM is fixed without using an adhesive, and a method of fabricating the same.

The present general inventive concept also provides a hard disk drive (HDD) in which an upper voice coil motor (VCM) block of a VCM is fixed using a crash stopper to restrict a pivot range of an actuator, and a method of fabricating the same.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a hard disk drive comprising a base member and a cover member of which outer circumferences are combined with each other to form an internal space, an actuator mounted on the base member to be pivoted, a voice coil motor (VCM) including a lower VCM block and an upper VCM block separated from each other so that a rear portion of the actuator is interposed therebetween, and a crash stopper to collide with the rear portion of the actuator and to restrict a pivot range of the actuator, and having an upper-end to be accommodated in the upper VCM block to prevent a location change of the upper VCM block caused by an external disturbance.

The crash stopper may include a pin having an upper-end to be accommodated in the upper VCM block, and a damper to surround an outer circumference of the pin.

The upper and lower VCM blocks each may include a magnet and a yoke to support the magnet, and a through hole formed in the yoke of the upper VCM block to accommodate the upper-end of the pin.

The upper end of the pin may include a first chamfer formed on the upper-end of the pin, and the through hole of the upper VCM block may include a second chamfer formed at a lower side of the through hole to correspond to the first chamfer of the pin.

The crash stopper may be inserted into and mounted on the base member.

The crash stopper may restrict a clockwise or counterclockwise pivot range of the actuator.

The upper VCM block may include at least one guide protrusion, and the lower VCM block may include at least one guide groove to accommodate the guide protrusion so that the upper VCM block is arranged with respect to the lower VCM block.

The upper VCM block may include at least one spacer supported on the lower VCM block so that a distance between the upper VCM block and the lower VCM block can be maintained.

The hard disk drive may include a pressing pad formed of an elastic material and attached to an inside of the cover member to prevent separation of the lower VCM block and the upper VCM block by pressing the upper VCM block toward the base member.

The foregoing and/or other aspects of the present general inventive concept may also be achieved by providing a method of fabricating a hard disk drive, the method comprising installing a voice coil motor (VCM) including a lower VCM block and an upper VCM block on a base member, mounting an actuator on the base member to be pivoted so that a rear portion of the actuator is interposed between the lower VCM block and the upper VCM block, forming a crash stopper to collide with the rear portion of the actuator and to restrict a pivot range of the actuator to protrude from the lower VCM block, and combining a cover member with an outer circumference of the base member by disposing an upper-end of the crash stopper to be accommodated in the upper VCM block to prevent a location change of the upper VCM block caused by an external disturbance.

The installing of the VCM and mounting of the actuator may include disposing the lower VCM block on the base member, mounting the actuator on the base member so that the rear portion is disposed on the lower VCM block, and disposing the upper VCM block on the lower VCM block and the rear portion of the actuator.

The forming of the crash stopper may include forming the crush stopper to protrude from the lower VCM block before disposing the upper VCM block, and the combining of the cover member and the base member may include disposing the upper VCM block on the lower VCM block and the rear portion of the actuator so that the upper-end of the crash stopper is accommodated in the upper VCM block.

The disposing of the upper VCM block on the lower VCM block may include inserting and mounting the crash stopper into and on the base member. The combining of the cover member and the base member may include attaching a pressing pad to an inside of the cover member and combining the cover member with the outer circumference of the base member so that the pressing pad presses the upper VCM block toward the base member to prevent the separation of the lower VCM block and the upper VCM block.

The foregoing and/or other aspects of the present general inventive concept may also be achieved by providing a hard disk drive including a base member, a cover member to form an internal space with the base member, an actuator mounted on the base member to be disposed in the internal space, a voice coil motor (VCM) including a lower VCM block and an upper VCM block which are separated from each other so that a rear portion of the actuator is interposed therebetween, and a crash stopper formed on one of the base member and the lower VCM block and coupled to the upper VCM block to restrict a movement of the actuator and to prevent a movement of the upper VCM block with respect to the one of the base member and the lower VCM block.

The foregoing and/or other aspects of the present general inventive concept may also be achieved by providing a hard disk drive including a base member, a cover member to be assembled with the base member, a voice coil motor (VCM) including a lower VCM block disposed on the base member and an upper VCM block disposed to be spaced-part from the lower VCM block by a distance, an actuator having a rear portion disposed between the lower VCM block and the upper VCM block, and a crash stopper having a pin to protrude from one of the base member and the lower VCM block and to be received by the upper VCM block to prevent a movement of the upper VCM block with respect to the one of the base member, and a damper disposed around the pin to restrict a movement of the actuator.

The foregoing and/or other aspects of the present general inventive concept may also be achieved by providing a hard disk drive including a base member, a cover member to be assembled with the base member, a voice coil motor (VCM) including a lower VCM block and an upper VCM block, an actuator disposed between the lower VCM block and the upper VCM block, a crash stopper to protrude from one of the base member and the lower VCM block to restrict a movement of the actuator, and having a distal end to be received by the upper VCM block to prevent a movement of the upper VCM block with respect to the base member, a pad disposed between the upper VCM block and the cover member, and a space disposed to maintain a distance between the upper VCM block and the lower VCM block.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view partially illustrating a conventional voice coil motor (VCM);

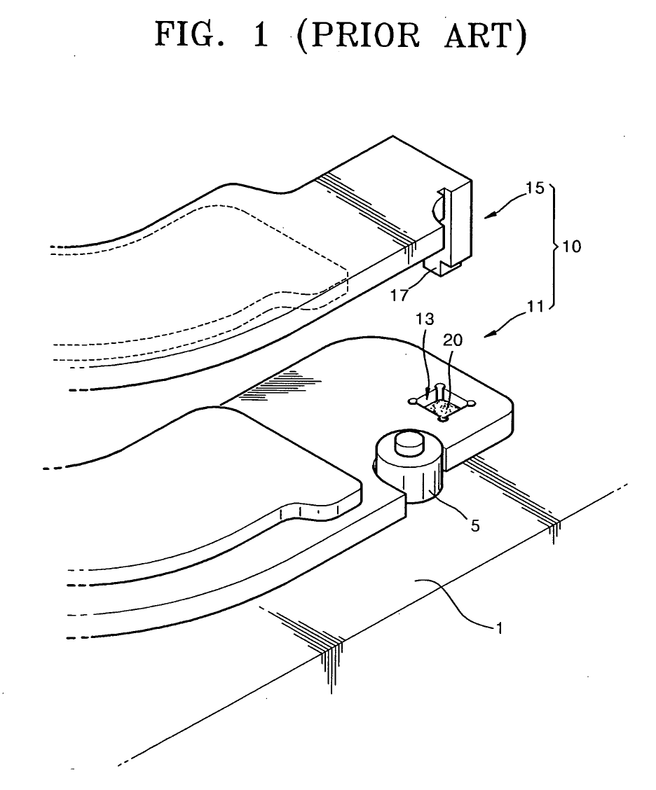

FIG. 2 is a plane view illustrating a hard disk drive (HDD) according to an embodiment of the present general inventive concept;

FIG. 3 is an exploded perspective view partially illustrating a VCM of the hard disk drive illustrated in FIG. 2; and

FIG. 4 is a cross-sectional view illustrating the VCM taken along line IV-IV of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

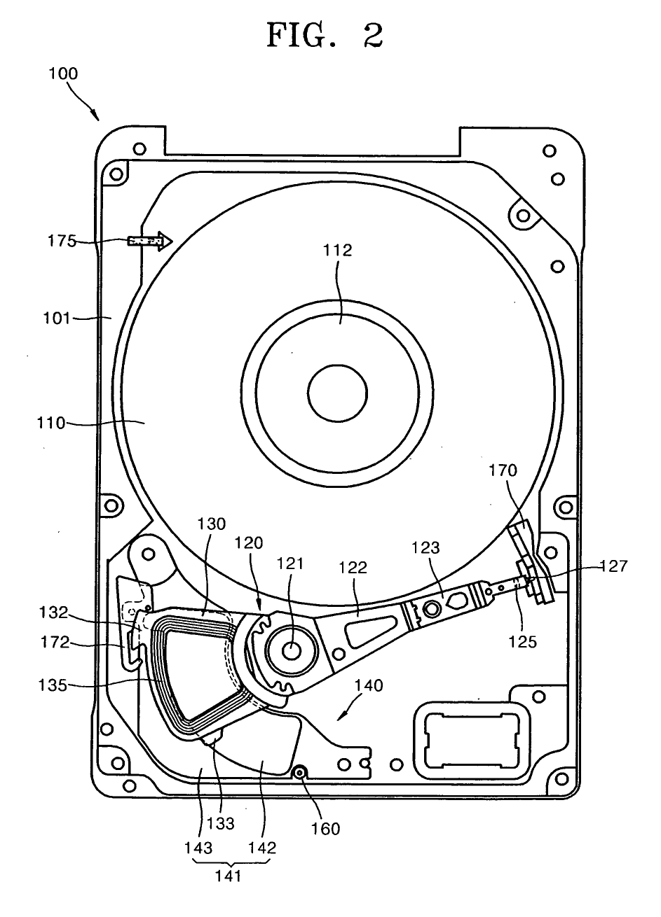

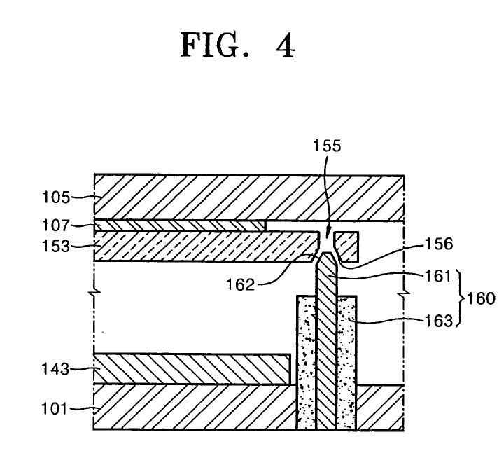

FIG. 2 is a plane view illustrating a hard disk drive (HDD) 100 according to an embodiment of the present general inventive concept. Referring to FIG. 2, the hard disk drive (HDD) 100 includes a spindle motor 112, a disk 110 mounted on the spindle motor 112, an actuator 120 that moves a magnetic head to record and reproduce data on or from a predetermined location of the disk 110, and a voice coil motor (VCM) 140 to pivot the actuator 120 inside a base member 101 and a cover member 105 (see FIG. 4), which are combined with each other. The base member 101 and the cover member 105 may be formed in a single monolithic body. The actuator 120 includes a swing arm 122 combined with a pivot center 121 disposed on the base member 101 of the HDD 100 to be rotated, and a suspension 123 installed on a front-end of the swing arm 122 to support a slider 125 which is mounted on the swing arm 122 to be elastically biased toward a surface of the disk 110. A VCM coil 135 is wound around a rear portion 130 of the actuator 120.

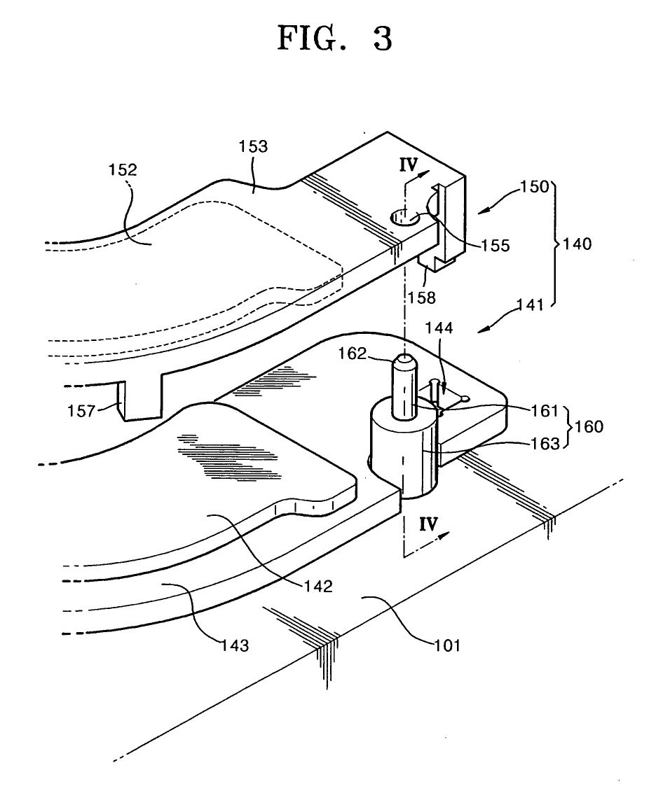

The VCM 140 includes a lower magnet 142 and an upper magnet 152 (see FIG. 3) which are disposed below and above the VCM coil 135, respectively, to face the VCM coil 135. The lower magnet 142 and the upper magnet 152 are attached to and supported by a lower yoke 143 and an upper yoke 153 (see FIG. 3). The lower magnet 142 and the upper magnet 152 are spaced-apart from each other to accommodate the rear portion of the actuator 120 (i.e., the voice coil 135). The lower magnet 142 and the lower yoke 143 constitute a lower VCM block 141, and the upper magnet 152 and the upper yoke 153 constitute an upper VCM block 150 (see FIG. 3). The lower VCM block 141 and the upper VCM block 150 are assembled with the rear portion 130 of the actuator 120 movably interposed therebetween, thereby forming the VCM 140

According to the Flemming's left hand rule, the actuator 120 pivots with respect to the pivot center 121 by an electromagnetic force generated by an interaction between a current which is input to the VCM coil 135 and a magnetic field formed by the upper and lower magnets 142 and 152. When the HDD 100 is turned on and the disk 110 starts rotating, the actuator 120 pivots counterclockwise, and the slider 125, on which the magnetic head is mounted, moves onto a recording surface of the disk 110. If the HDD 100 is turned off and the disk 110 stops rotating, the actuator 120 pivots clockwise and the slider 125 deviates from surface of the disk 110. In this case, the slider 125 is parked on a ramp 170 disposed on an outer circumference of the disk 110. Specifically, an end-tap 127 formed on the front-end of the suspension 123 is lifted on the ramp 170 and parked thereon. It is possible that the slider 125 may rest on a parking zone inside the disk 110 in a parking condition mode.

The HDD 100 includes an actuator latch 172. When the HDD 100 stops operating, and the disk 110 stops rotating and the slider 125 is parked on the ramp 170, the actuator latch 172 interferes with a hook 132 of the rear portion 130 of the actuator 120 and locks the actuator 120. Thus, the slider 125 and the disk 110 are prevented from being damaged by an external disturbance. A circulation filter 175 is disposed in one corner of the base member 101 adjacent to an outer circumference of the disk 110. The circulation filter 175 filters foreign substances such as particles contained in an air flow induced by high-speed rotation of the disk 110.

The HDD 100 includes a crash stopper 160 which restricts a counterclockwise pivot range of the actuator 120. The actuator 120 that pivots counterclockwise with respect to the pivot center 121 stops moving when a crash stopper collision part 133 formed in the rear portion 130 of the actuator 120 collides with the crash stopper 160. As such, the actuator 120 and the spindle motor 112 are prevented from colliding with each other because of the external disturbance.

FIG. 3 is an exploded perspective view partially illustrating the VCM 140 of the HDD 100 illustrated in FIG. 2, and FIG. 4 is a cross-sectional view illustrating the VCM 140 taken along line IV-IV of FIG. 3.

Referring to FIGS. 3 and 4, the crash stopper 160 includes a pin 161 and a damper 163 which surrounds an outer circumference of the pin 161. The pin 161 is formed of a metal such as stainless steel, and the damper 163 is formed of a shock-absorbing material, such as a rubber, to absorb a shock when colliding with the crash stopper collision part 133 (see FIG. 2). The crash stopper 160 is inserted and mounted on the base member 101, and protrudes from the lower VCM block 141 toward the upper VCM block 150. The crash stopper 160 may have a height higher than a sum of a thickness of the lower yoke 143 of the lower VCM block 140 and a distance between the upper yoke 153 of the upper VCM block 150 and the lower yoke of the lower VCM block 141, so that an upper end of the crash stopper 160 is inserted into the upper yoke 153 of the upper VCM block 150. However, the crash stopper 160 of the present embodiment may be formed in one body with the base member 101 or mounted on the lower VCM block 141.

An upper-end of the pin 161 extends toward the upper VCM block 150 and is accommodated in the upper yoke 153. A through hole 155 is formed in the upper yoke 153 to accommodate the upper-end of the pin 161. The upper-end of the pin 161 may be formed with a first chamfer 162 having an edge gently processed so that the upper-end of the pin 161 can be easily accommodated in the through hole 155. The upper yoke 153 of the upper VCM block 150 may include a second chamfer 156 formed at a lower side of the through hole 155 and having an edge gently processed to correspond to the first chamfer 162 of the pin 161. At least one of the first chamfer 162 and the second chamfer 156 may have a shape of a frustum of a cone of which end area becomes smaller as being closer to the upper VCM block 150.

The HDD 100 has a small size, and the disk 110 has a diameter of equal to or less than 2.5 inch. The HDD 100 is assembled using a top-down method using an automation production facility to increase productivity. In the top-down method, the lower VCM block 141 is disposed on the base member 101, the actuator 120 is mounted on the base member 101 so that the rear portion 130 of the actuator 120 can be disposed on the lower VCM block 141, and the upper VCM block 150 is disposed on the lower VCM block 141 and the rear portion 130 of the actuator 120.

In order to arrange the upper VCM block 150 with respect to the lower VCM block 141 in the assembling procedure, the upper VCM block 141 includes at least one guide protrusion 158, and the lower VCM block 150 includes at least one guide groove 144 to accommodate the corresponding guide protrusion 158. Another chamfer may also be formed in the guide groove 144 so that the guide protrusion 158 can easily come into the guide groove 144. The lower VCM block 141 and the upper VCM block 150 do not need to be combined with each other and thus, an adhesive may not be used in the HDD.

The lower magnet 142 and the upper magnet 152 of the VCM 140 are separated from each other by a predetermined distance so that the rear portion 130 of the actuator 120 can be interposed therebetween. The upper VCM block 150 includes at least one spacer 157 directly supported on the lower yoke 143 so that the distance can be maintained.

To improve productivity, reduce production cost, and reduce the weight of the HDD 100, the lower VCM block 141 and the upper VCM block 150 may not be combined with each other using a screw. The HDD 100 includes a pressing pad 107 formed of an elastic material attached to an inside of the cover member 105. The pressing pad 170 may be disposed between an inside surface of the cover member 105 and an upper surface of the yoke 153 of the upper VCM block 150. When the cover member 105 is combined with the base member 101, since the pressing pad 107 presses the upper yoke 153 of the upper VCM block 150 toward the base member 101, the separation of the lower VCM block 141 and the upper VCM block 150 is suppressed.

The upper-end of the pin 161 of the crash stopper 160 fixed on the base member 101 is accommodated in the upper VCM block 150, the guide protrusion 158 of the upper VCM block 150 is accommodated in the guide groove 144 of the lower VCM block 141, and the upper VCM block 150 is pressed by the pressing pad 107 attached to the cover member 105 so that it cannot be separated from the lower VCM block 141. Thus, even when a shock is applied to the HDD 100, the position of the upper VCM block 150 does not change with respect to the base member 101 or the lower VCM block 141. A length of the damper 163 may be a distance between the base member 101 and a lower surface of the upper yoke 153 of the upper VCM block 150 in a direction of a longitudinal direction of the pin 161. It is possible that the length may be a distance between an upper surface of the lower yoke of the lower VCM block 141 and the lower surface of the upper yoke of the upper VCM block 150. It is also possible that the length of the damper 163 is longer than the distance before the cover member 105 is assembled with the base member 101, but is shortened with respect to the pin 161 by the distance since the damper 163 is an elastic material, when the cover member 105 is assembled with the base member 101.

A method of fabricating the HDD 100 will now be described with reference to FIGS. 2 through 4. As described above, the HDD 100 is assembled using the top-down method using an automation productivity facility. First, the spindle motor 112 is mounted on the base member 101 and the disk 110 is fixedly combined with the spindle motor 112. In addition, the ramp 170 is mounted on the base member 101 and the crash stopper 160 is inserted on the base member 101. Next, the lower VCM block 141 is disposed on the base member 101. After that, the actuator 120 is mounted on the base member 101 so that the rear portion 130 of the actuator 120 is located on the lower VCM block 141, and the actuator latch 172 is installed. Next, the upper VCM block 150 is disposed on the lower VCM block 141 and the rear portion 130 of the actuator 120.

When the guide protrusion 158 of the upper VCM block 150 is disposed on the guide groove 144 of the lower VCM block 141, and the upper VCM block 150 is disposed on the lower VCM block 141 and the rear portion 130 of the actuator 120, the guide protrusion 158 is inserted in the guide groove 144, and at the same time, the pin 161 of the crash stopper 160 protruding in an upward direction toward the upper VCM block 150 is inserted through the through hole 155 of the upper VCM block 150.

Next, the circulation filter 175 is mounted to an outer perimeter of the disk 110. The cover member 105 is combined with the base member 101. The pressure pad 107 inside the cover member 105 presses the upper VCM block 150 toward the base member 101 to prevent the separation of the upper VCM block 150 and the lower VCM block 141.

As described above, in the HDD according to the present embodiment, the upper-end of the crash stopper prevents a location change of the upper VCM block caused by an external disturbance such that malfunction and damage of the actuator are prevented.

In addition, since an additional fixing unit to fix the upper VCM block with respect to the lower VCM block is not needed, the manufacturing cost of the HDD can be reduced and miniaturization and weight reduction of the hard disk drive are possible.

Furthermore, in the method of fabricating the hard disk drive according to the present embodiment, an adhesive may not be used and top-down assembling can be performed using the automation production facility. Thus, assembly productivity can be improved and manufacturing cost can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A hard disk drive comprising:
a base member and a cover member of which outer circumferences are combined with each other to form an internal space;
an actuator mounted on the base member to be pivoted;
a voice coil motor (VCM) including a lower VCM block and an upper VCM block separated from each other so that a rear portion of the actuator is interposed therebetween; and
a crash stopper to collide with the rear portion and to restrict a pivot range of the actuator, and having an upper-end to be accommodated in the upper VCM block so that a location change of the upper VCM block caused by an external disturbance is prevented.

2. The hard disk drive of claim 1, wherein the crash stopper comprises a pin of which upper-end is accommodated in the upper VCM block, and a damper to surround an outer circumference of the pin.

3. The hard disk drive of claim 2, wherein the upper and lower VCM blocks each comprise a magnet and a yoke to support the magnet, and the upper VCM block comprises a through hole in which the upper-end of the pin is accommodated is formed in the yoke of the upper VCM block.

4. The hard disk drive of claim 3, wherein the upper-end of the pin comprises a first chamfer, and the upper yoke of the upper VCM block comprises a second chamfer formed on a lower side of the through hole to correspond to the first chamfer of the pin.

5. The hard disk drive of claim 1, wherein the crash stopper is inserted into or mounted on the base member.

6. The hard disk drive of claim 1, wherein the crash stopper restricts a pivot range of the actuator in a clockwise or counterclockwise direction.

7. The hard disk drive of claim 1, wherein the upper VCM block comprises at least one guide protrusion, and the lower VCM block comprises at least one guide groove to accommodate the guide protrusion so that the upper VCM block is arranged with the lower VCM block.

8. The hard disk drive of claim 1, wherein the upper VCM block comprises at least one spacer supported on the lower VCM block to maintain a distance between the upper VCM block and the lower VCM block.

9. The hard disk drive of claim 1, further comprising:
a pressing pad formed of an elastic material attached to an inside of the cover member to prevent separation of the lower VCM block and the upper VCM block by pressing the upper VCM block toward the base member.

10. A method of fabricating a hard disk drive, the method comprising:
installing a voice coil motor (VCM) including a lower VCM block and an upper VCM block on a base member;
mounting an actuator on the base member to be pivoted so that a rear portion of the actuator is interposed between the lower VCM block and the upper VCM block;
forming a crash stopper colliding with the rear portion and restricting a pivot range of the actuator to protrude from the lower VCM block; and
combining a cover member with an outer circumference of the base member when an upper-end of the crash stopper is accommodated in the upper VCM block to prevent a location change of the upper VCM block caused by an external disturbance.

11. The method of claim 10, wherein the installing of the VCM and mounting of the actuator comprises:
disposing the lower VCM block on the base member;
mounting the actuator on the base member so that the rear portion of the actuator is disposed on the lower VCM block; and
disposing the upper VCM block on the lower VCM block and the rear portion of the actuator.

12. The method of claim 11, wherein the forming of the crash stopper comprises forming the crash stopper to protrude from the lower VCM block before disposing the upper VCM block, and the combining of the cover member and the base member comprises disposing the upper VCM block on the lower VCM block and the rear portion of the actuator so that the upper-end of the crash stopper is accommodated in the upper VCM block.

13. The method of claim 10, wherein the forming of the crash stopper comprises forming the crash stopper to be inserted into or mounted on the base member.

14. The method of claim 10, wherein the combining of the cover member and the base member comprises attaching a pressing pad to an inside of the cover member, and combining the cover member with the outer circumference of the base member to press the upper VCM block toward the base member through the pressing pad so that the separation of the lower VCM block and the upper VCM block is prevented.

15. A hard disk drive comprising:
a base member;
a cover member to be assembled with the base member;
a voice coil motor (VCM) including a lower VCM block disposed on the base member and an upper VCM block disposed to be spaced-part from the lower VCM block by a distance;
an actuator having a rear portion disposed between the lower VCM block and the upper VCM block; and
a crash stopper having a pin to protrude from one of the base member and the lower VCM block and to be received by the upper VCM block to prevent a movement of the upper VCM block with respect to the one of the base member, and a damper disposed around the pin to restrict a movement of the actuator.

16. The hard disk drive of claim 15, wherein a surface of the upper VCM block has an area to correspond to that of a distal end of the pin, and the area of the surface is larger than that of the distal end of the pin.

17. The hard disk drive of claim 15, wherein:
the pin comprises a main shaft; and
a distal end of the pin is extended from the main shaft to have a shape of a frustum of a cone.

18. The hard disk drive of claim 16, wherein:
the upper VCM block comprises a guide protrusion;
the lower VCM block comprises a guide groove formed to receive the guide protrusion of the upper VCM block when the cover member and the base member are assembled; and
the guide protrusion and the guide groove do not have an adhesive therebetween.

19. The hard disk drive of claim 15, wherein the damper has a length in a longitudinal direction of the pin, and the length of the damper is equal to or less than a distance between the upper VCM block and the lower VCM block.

20. The hard disk drive of claim 15, wherein the damper has a length in a longitudinal direction of the pin, and the length of the damper is greater than a distance between the upper VCM block and the lower VCM block before the cover member and the base member is assembled.

21. The hard disk drive of claim 20, wherein the length of the damper is equal to the distance between the upper VCM block and the lower VCM block after the cover member and the base member is assembled.

22. The hard disk drive of claim 15, wherein:
the upper VCM block comprises an upper yoke and an upper magnet;
the lower VCM block comprises a lower yoke and a lower magnet to face the upper magnet of the upper VCM block;
the portion of the actuator is disposed between the upper magnet and the lower magnet; and
one of the upper yoke and the lower yoke comprises a spacer formed thereon to protrude toward the other one of the upper yoke and the lower yoke to maintain a distance between the upper yoke and the lower yoke.

23. The hard disk drive of claim 22, wherein the spacer is formed in a single monolithic body with one of the lower yoke and the upper yoke.

24. The hard disk drive of claim 15, wherein the pin of the crash stopper is formed in a single monolithic body with one of the lower VCM block and the base member.
